(19) United States
(12) Patent Application Publication
(10) Pub. No.: US 2023/0336429 A1
(43) Pub. Date: Oct. 19, 2023

(54) COMMUNICATION SYSTEM, CONTROL METHOD, CONTROL APPARATUS AND PROGRAM

(71) Applicant: NIPPON TELEGRAPH AND TELEPHONE CORPORATION, Tokyo (JP)

(72) Inventor: Yushi KOYASAKO, Musashino-shi, Tokyo (JP)

(73) Assignee: NIPPON TELEGRAPH AND TELEPHONE CORPORATION, Tokyo (JP)

(21) Appl. No.: 18/026,108

(22) PCT Filed: Sep. 16, 2020
(86) PCT No.: PCT/JP2020/035046

§ 371 Date: Mar. 13, 2023

(51) Int. Cl. H04L 41/12

(52) U.S. Cl. CPC H04L 41/12

(57) ABSTRACT

A communication system is a communication system including a device and a control device, the device includes a device communication unit that transmits identification information of the device to the control device in a case where the device is connected to the control device, and transmits setting information to the control device in a case where transmission of the setting information is requested, and the control device includes: an identification unit that acquires the identification information of the device; an update unit that updates network configuration information by adding the identification information of the device to the network configuration information; a request unit that transmits a signal for requesting transmission of the setting information to the device; a connection control unit that acquires the setting information; and a device control unit that transmits a notification signal to the device.

### TECHNICAL FIELD

The present invention relates to a communication system, a control method, a control device, and a program.

### BACKGROUND ART

In a communication system, communication between a device and a control device may be established using a predetermined protocol. FIG. 14 is a diagram illustrating a configuration example of a communication system 10. The communication system 10 includes a device 11, a switch 12, a control device 13, and a support device 14.

The device 11 is, for example, a sensor or a motor. In FIG. 14, the device 11 is connected to the switch 12. The switch 12 is a device (I/O device) that switches a path of data transmitted between the device 11 and the control device 13. The control device 13 is a device that controls the operation of the device 2. The support device 14 is an information processing device such as a personal computer or a human machine interface (HMI). The support device 14 is operated by a user. When the predetermined protocol is, for example, PROFINET (see Non Patent Literature 1), a general station description (GSD) file 15 is a setting file of a communication specification of the device 2. The GSD file 15 is prepared in advance by a manufacturer of the device 11, for example.

Hereinafter, information indicating a setting value related to communication or control of the device is referred to as “setting information”. The setting value is determined according to a communication specification or a control specification of the device. The support device 14 is connected to the control device 13. The user manually operates an engineering tool operating in the support device 14 to cause the control device 13 to read the setting information such as the control cycle. This enables data exchange between the device 11 and the control device 13.

### CITATION LIST

### Non Patent Literature

Non Patent Literature 1: “PROFINET System Explanations (Japanese version) 2.6 System Engineering,” [online], Japan Profibus Association, [Retrieved on Sep. 3, 2020], Internet <URL:http://www.profibus.jp/download/document.html>

### SUMMARY OF INVENTION

### Technical Problem

In this way, in order to establish communication between the control device and the device, it is necessary for the user to manually operate an engineering tool for causing the control device to read the setting file including the setting information to cause the control device to recognize the communication specification (for example, the network topology, the control cycle of the device) of the communication system.

In view of the above circumstances, an object of the present invention is to provide a communication system, a control method, a control device, and a program capable of establishing communication between a control device and a device without requiring operation of an engineering tool.

### Solution to Problem

According to an aspect of the present invention, there is provided a communication system including a device and a control device, in which the device includes a device communication unit configured to transmit identification information of the device to the control device in a case where the device is connected to the control device, and to transmit setting information regarding communication or control of the device to the control device in a case where transmission of the setting information is requested, and the control device includes: an identification unit configured to acquire the identification information of the device from the device communication unit; an update unit configured to update network configuration information that is information indicating a configuration of a network including the control device by adding the identification information of the device to the network configuration information; a request unit configured to transmit a signal for requesting transmission of the setting information to the device on the basis of the network configuration information; a connection control unit configured to acquire the setting information from the device communication unit; and a device control unit configured to transmit a notification signal indicating that communication has been established to the device.

According to another aspect of the present invention, there is provided a control method executed by a communication system including a device and a control device, the control method including: transmitting, by the device, identification information of the device to the control device in a case where the device is connected to the control device, and transmitting, by the device, setting information regarding communication or control of the device to the control device in a case where transmission of the setting information is requested; acquiring, by the control device, the identification information of the device from the device; updating, by the control device, network configuration information that is information indicating a configuration of a network including the control device by adding the identification information of the device to the network configuration information; transmitting, by the control device, a signal for requesting transmission of the setting information to the device on the basis of the network configuration information; acquiring, by the control device, the setting information from the device; and transmitting, by the control device, a notification signal indicating that communication has been established to the device.

According to still another aspect of the present invention, there is provided a control device including: an identification unit configured to acquire identification information of a device requesting establishment of communication, from the device; an update unit configured to update network configuration information that is information indicating a configuration of a network including the control device by adding the identification information of the device to the network configuration information; a request unit configured to transmit a signal for requesting transmission of setting information regarding communication or control of the device to the device on the basis of the network configuration information; a connection control unit configured to acquire the setting information from the device; and a device control unit configured to transmit a notification signal indicating that communication has been established to the device.

According to still another aspect of the present invention, there is provided a program for causing a computer to function as the control device.

### Advantageous Effects of Invention

According to the present invention, it is possible to establish communication between the control device and the device without requiring operation of the engineering tool.

### BRIEF DESCRIPTION OF DRAWINGS

FIG. 1 is a diagram illustrating a configuration example of a communication system in a first embodiment.

FIG. 2 is a sequence diagram illustrating an operation example of the communication system in the first embodiment.

FIG. 3 is a diagram illustrating a configuration example of a communication system in a second embodiment.

FIG. 4 is a sequence diagram illustrating an operation example of the communication system in the second embodiment.

FIG. 5 is a diagram illustrating a first modification example of the configuration of the communication system in the second embodiment.

FIG. 6 is a diagram illustrating a second modification example of the configuration of the communication system in the second embodiment.

FIG. 7 is a diagram illustrating a third modification example of the configuration of the communication system in the second embodiment.

FIG. 8 is a diagram illustrating a configuration example of a communication system in a third embodiment.

FIG. 9 is a sequence diagram illustrating an operation example of the communication system in the third embodiment.

FIG. 10 is a diagram illustrating a first modification example of the configuration of the communication system in the third embodiment.

FIG. 11 is a diagram illustrating a second modification example of the configuration of the communication system in the third embodiment.

FIG. 12 is a diagram illustrating a third modification example of the configuration of the communication system in the third embodiment.

FIG. 13 is a diagram illustrating a hardware configuration example of a communication system in each embodiment.

FIG. 14 is a diagram illustrating a configuration example of a communication system in the related art.

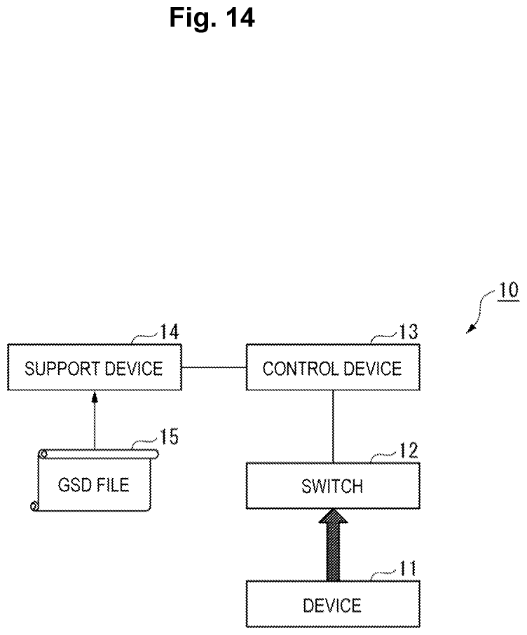

### DESCRIPTION OF EMBODIMENTS

Embodiments of the present invention will be described in detail with reference to the drawings.

### First Embodiment

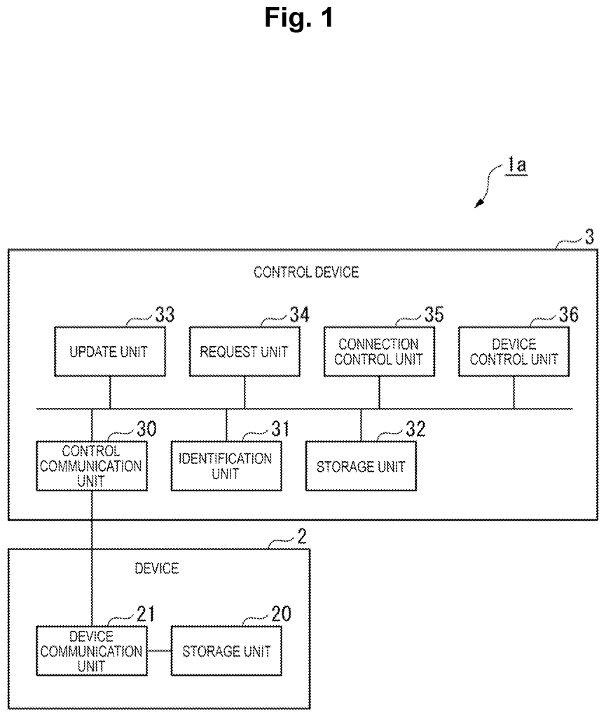

FIG. 1 is a diagram illustrating a configuration example of a communication system 1a. The communication system 1a is a system in which a device and a control device communicate with each other using a predetermined protocol. The predetermined protocol is, for example, an industrial Ethernet (registered trademark) protocol. The protocol is, for example, “PROFINET” or “EtherNet/IP” (“ETHERNET” is a registered trademark).

The communication system 1a includes a device 2 and a control device 3. The device 2 includes a storage unit 20 and a device communication unit 21. The control device 3 includes a control communication unit 30, an identification unit 31, a storage unit 32, an update unit 33, a request unit 34, a connection control unit 35, and a device control unit 36.

The device 2 is a device for industrial use, such as, for example, a sensor, a motor, an inverter, a robot, or the like. When the device 2 is connected to the control device 3, the device 2 transmits a signal for requesting establishment of communication (hereinafter referred to as an “establishment request signal”) to the control device 3 as a communication request. The establishment request signal includes, for example, identification information of a device that requests establishment of communication.

The device 2 acquires a signal for requesting transmission of setting information (hereinafter referred to as a “setting request signal”) from the control device 3. The device 2 acquires, from the control device 3, a notification signal indicating that communication between the control device and the device has been established (hereinafter referred to as an “establishment notification signal”). After the communication between the control device 3 and the device 2 is established, the device 2 outputs, for example, a sensor value to the control device 3.

The control device 3 is a device that controls the operation of the device 2. The control device 3 acquires an establishment request signal including identification information of the device 2 connected to the control device 3 from the device 2. The control device 3 updates information indicating the configuration of the network (hereinafter referred to as “network configuration information”) on the basis of the establishment request signal. The network configuration information includes identification information of the device 2 and network topology information. Thus, the control device 3 recognizes the network topology in the communication system 1a.

The control device 3 may recognize the network topology of the communication system 1a using a link layer discovery protocol (LLDP).

The control device 3 transmits a setting request signal to the device 2. The control device 3 acquires setting information from the device 2. The control device 3 generates a signal for controlling the operation of the device 2 (hereinafter referred to as a “control signal”) on the basis of the setting information. The control device 3 transmits an establishment notification signal to the device 2.

After the communication between the control device 3 and the device 2 is established, the control device 3 controls the operation of the device 2 by transmitting a control command to the device 2. The control device 3 acquires, for example, a sensor value transmitted from the device 2. The control device 3 may generate a new control command on the basis of the acquired sensor value.

Next, details of the device 2 will be described.

The storage unit 20 stores setting information of the device 2. The device communication unit 21 acquires the setting information (for example, information on the control cycle) of the device 2 from the storage unit 20.

When connected to the control device 3, the device communication unit 21 transmits an establishment request signal to the control device 3. Upon acquiring the setting request signal from the control device 3, the device communication unit 21 returns the setting information of the device 2 to the control device 3. Upon acquiring a frame of a link layer discovery protocol (LLDP) from the control device 3, the device communication unit 21 may return the identification information and the setting information of the device 2 to the control device 3.

Next, details of the control device 3 will be described.

The control communication unit 30 executes communication between the control device 3 and the device 2. The identification unit 31 identifies the device 2 that has transmitted the signal acquired by the control communication unit 30. For example, the identification unit 31 identifies the device 2 that has transmitted the establishment request signal on the basis of the identification information included in the establishment request signal acquired by the control communication unit 30.

The storage unit 32 stores network configuration information of the communication system 1a. In addition, the storage unit 32 stores the setting information for each device 2.

The update unit 33 refers to the network configuration information stored in the storage unit 32. The update unit 33 adds the identification information of the device 2 connected to the control device 3 to the network configuration information as information of a device newly connected to the network. Thus, the update unit 33 updates the network configuration information.

The request unit 34 transmits a setting request signal to the device 2 using the control communication unit 30 on the basis of the network configuration information. The connection control unit 35 updates the setting information regarding the device 2 that has transmitted the setting information acquired by the control communication unit 30 on the basis of the setting information.

The device control unit 36 takes over the control of the operation of the device 2 from the connection control unit 35. That is, the device control unit 36 uses the device communication unit 21 to transmit an establishment notification signal to the device 2 that has transmitted the acquired setting information on the basis of the setting information.

The device control unit 36 generates a control signal on the basis of the setting information. The device control unit 36 controls the operation of the device 2 by transmitting a control signal to the device 2 for which communication is established. The device control unit 36 acquires, for example, a sensor value as a response to the control signal from the device 2 that has acquired the control signal.

Next, an operation example of the communication system 1a will be described.

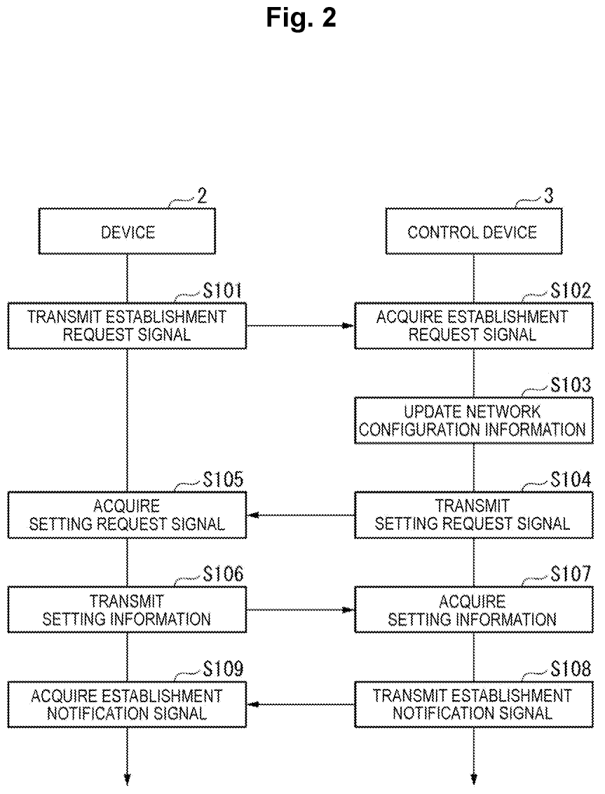

FIG. 2 is a sequence diagram illustrating an operation example of the communication system 1a. The operation illustrated in FIG. 2 is executed when the device 2 is connected to the control device 3 (when the device 2 is connected to the network). The device 2 transmits an establishment request signal to the control device 3 (step S101). The control device 3 acquires the establishment request signal from the device 2 (step S102). The control device 3 updates the network configuration information on the basis of the establishment request signal (step S103).

The control device 3 transmits a setting request signal to the device 2 (step S104). The device 2 acquires the setting request signal from the control device 3 (step S105). The device 2 transmits setting information to the control device 3 (step S106). The control device 3 acquires the setting information from the device 2 (step S107). The control device 3 transmits an establishment notification signal to the device 2 (step S108). The device 2 acquires the establishment notification signal from the control device 3 (step S109).

As described above, when the device 2 is directly or indirectly connected to the control device 3, the device communication unit 21 transmits identification information of the device 2 to the control device 3. In a case where transmission of setting information regarding communication or control of the device 2 is requested, the device communication unit 21 transmits the setting information of the device 2 to the control device 3. The identification unit 31 acquires the identification information of the device 2 from the device communication unit 21. The update unit 33 updates the network configuration information by adding the identification information of the device 2 to the network configuration information that is information indicating the configuration of the network including the control device 3 (own control device). The request unit 34 transmits a setting request signal to the device 2 on the basis of the network configuration information. The connection control unit 35 acquires the setting information of the device 2 from the device communication unit 21. When the setting information is acquired, the connection control unit 35 or the device control unit 36 transmits an establishment notification signal to the device 2 on the basis of the network configuration information.

Thus, it is possible to establish communication between the control device and the device without requiring operation of the engineering tool. This is not limited to a particular protocol.

Communication between the control device 3 and the device 2 is established simply by the user connecting the device 2 to the control device 3 of the existing network. Therefore, the workload of the user is reduced. In a case where the device 2 is a sensor or the like, the user may not add a setting to the setting information of the device 2 after communication between the control device 3 and the device 2. In a case where the device 2 is a motor or the like, the user may add a setting to the setting information of the device 2 after communication between the control device 3 and the device 2.

### Second Embodiment

A second embodiment is different from the first embodiment in that a communication system includes a switch. In the second embodiment, differences from the first embodiment will be mainly described.

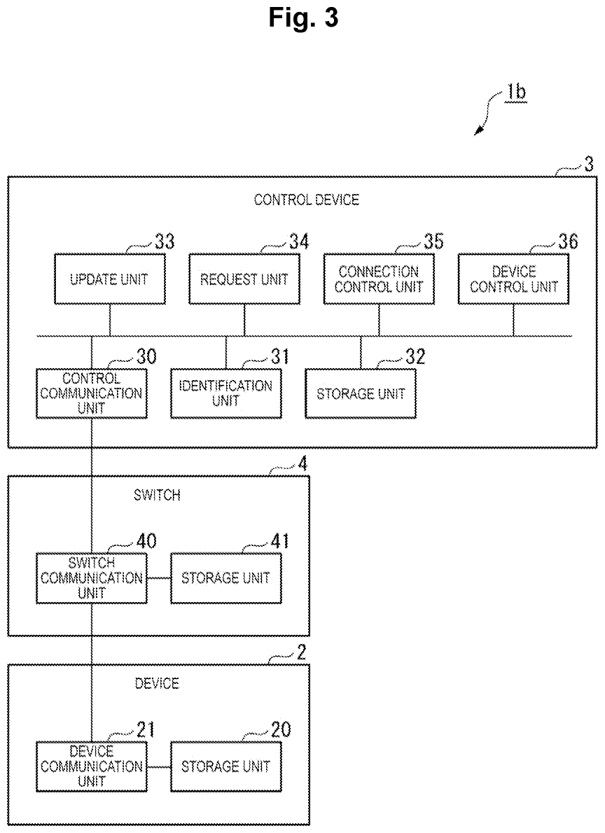

FIG. 3 is a diagram illustrating a configuration example of a communication system 1b. The communication system 1b includes a device 2, a control device 3, and a switch 4. The switch 4 includes a switch communication unit 40 and a storage unit 41.

When the device 2 is connected to the switch 4, the device 2 transmits an establishment request signal (packet) to the control device 3 as a communication request.

The switch communication unit 40 executes communication between the control device 3 and the switch 4. The switch communication unit 40 executes communication between the device 2 and the switch 4. The switch communication unit 40 transmits, to the control device 3, a signal for requesting a flow entry related to the signal of the device that has transmitted the establishment request signal (hereinafter referred to as a “flow entry request signal”). The switch communication unit 40 acquires the flow entry of the device 2 from the control device 3. The switch communication unit 40 records the flow entry of the device 2 in the storage unit 41.

The storage unit 41 stores a flow table. The flow table includes one or more flow entries. In the flow entry, for example, “Match Field” and “Instruction” are associated with each other. “Match Field” represents a condition for identifying a flow. “Instruction” represents processing to be executed on a signal (packet) satisfying the condition set to “Match Field”. That is, a signal matching the condition set to “Match Field” is processed in accordance with “Instruction”.

Next, an operation example of the communication system 1b will be described.

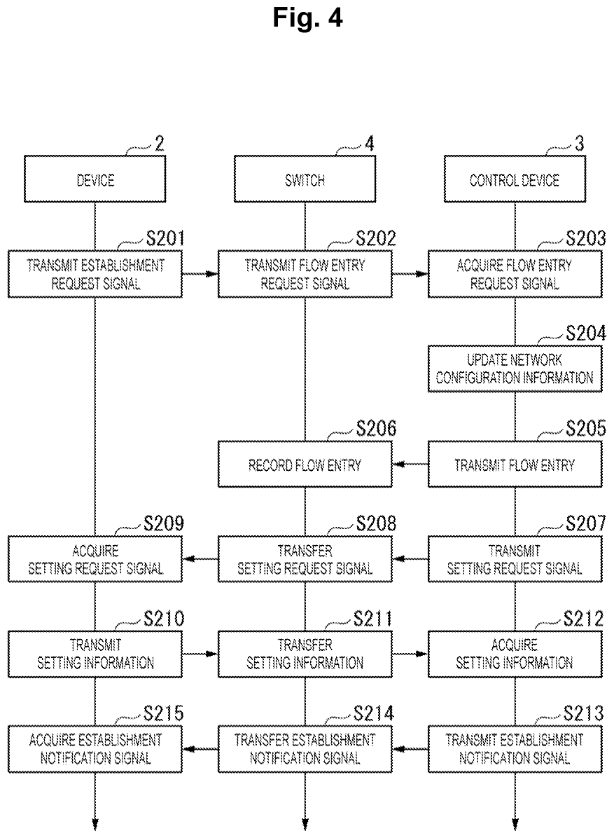

FIG. 4 is a sequence diagram illustrating an operation example of the communication system 1b. The operation illustrated in FIG. 4 is executed when the switch 4 is connected to the control device 3. The device 2 transmits an establishment request signal to the switch 4 (step S201). The switch 4 transmits a flow entry request signal to the control device 3 on the basis of the establishment request signal (step S202).

The control device 3 acquires the flow entry request signal from the switch 4 (step S203). The control device 3 updates the network configuration information on the basis of the flow entry request signal (step S204). The control device 3 transmits the flow entry related to the signal of the device 2 to the switch 4 (step S205). The switch 4 records the flow entry related to the signal of the device 2 in the flow table (step S206).

The control device 3 transmits a setting request signal to the device 2 (step S207). The switch 4 transfers the setting request signal to the device 2 (step S208). The device 2 acquires the setting request signal from the switch 4 (step S209). The device 2 transmits the setting information of the device 2 to the switch 4 (step S210). The switch 4 transmits the setting information of the device 2 to the control device 3 (step S211). The control device 3 acquires the setting information of the device 2 from the switch 4 (step S212).

The control device 3 transmits an establishment notification signal to the switch 4 (step S213). The switch 4 transfers the establishment notification signal to the device 2 on the basis of the flow entry related to the signal of the device 2 (step S214). The device 2 acquires the establishment notification signal from the switch 4 (step S215).

As described above, when the device 2 is connected to the control device 3 via the switch 4, the device communication unit 21 transmits identification information of the device 2 to the control device 3. In a case where transmission of setting information regarding communication or control of the device 2 is requested, the device communication unit 21 transmits the setting information of the device 2 to the control device 3 via the switch 4. The identification unit 31 acquires the identification information of the device 2 from the device communication unit 21. The update unit 33 updates the network configuration information by adding the identification information of the device 2 to the network configuration information that is information indicating the configuration of the network including the control device 3 (own control device). The request unit 34 transmits a setting request signal to the device 2 on the basis of the network configuration information. The connection control unit 35 acquires the setting information of the device 2 from the device communication unit 21. When the setting information is acquired, the connection control unit 35 or the device control unit 36 transmits an establishment notification signal to the device 2 on the basis of the network configuration information.

Thus, it is possible to establish communication between the control device and the device without requiring operation of the engineering tool.

Next, a modification example will be described.

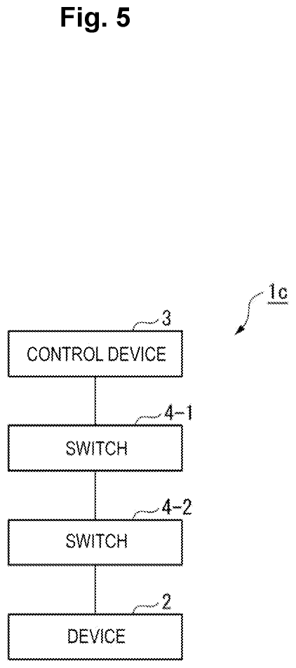

FIG. 5 is a diagram illustrating a first modification example of the configuration of the communication system 1b. A communication system 1c includes a device 2, a control device 3, a switch 4-1, and a switch 4-2. The communication system 1c may further include a switch 4.

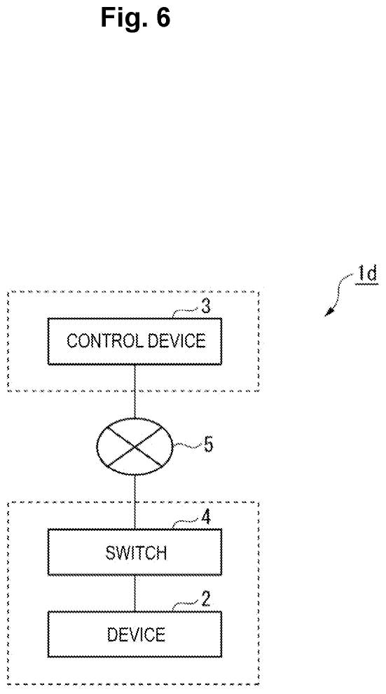

FIG. 6 is a diagram illustrating a second modification example of the configuration of the communication system 1b. A communication system 1d includes a device 2, a control device 3, a switch 4, and a communication line 5. The communication line 5 may be, for example, an electric line such as Ethernet (registered trademark) or an optical line such as passive optical network (PON). The control device 3 communicates with the device 2 via the communication line 5 and the switch 4. The control device 3 is provided at a first base. The device 2 and the switch 4 are provided at a second base. The communication system 1d may further include a switch 4.

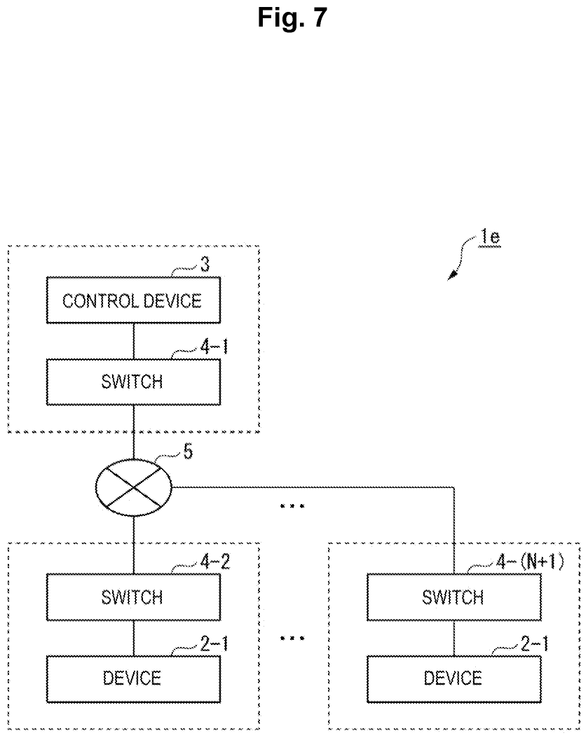

FIG. 7 is a diagram illustrating a third modification example of the configuration of the communication system 1b. A communication system 1e includes N (N is an integer of 3 or more) devices 2, a control device 3, “N+1” switches 4, and a communication line 5. The control device 3 communicates with the device 2-n (n is any integer from 1 to N) via the switch 4-1, the communication line 5, and the switch 4-(n+1).

The control device 3 is provided at a first base. The device 2-1 and the switch 4-2 are provided at a second base. The device 2-N and the switch 4-(N+1) are provided at an N-th base. The communication system 1e may further include a switch 4.

### Third Embodiment

A third embodiment is different from the first and second embodiments in that a communication system includes a support device. In the third embodiment, differences from the first and second embodiments will be mainly described.

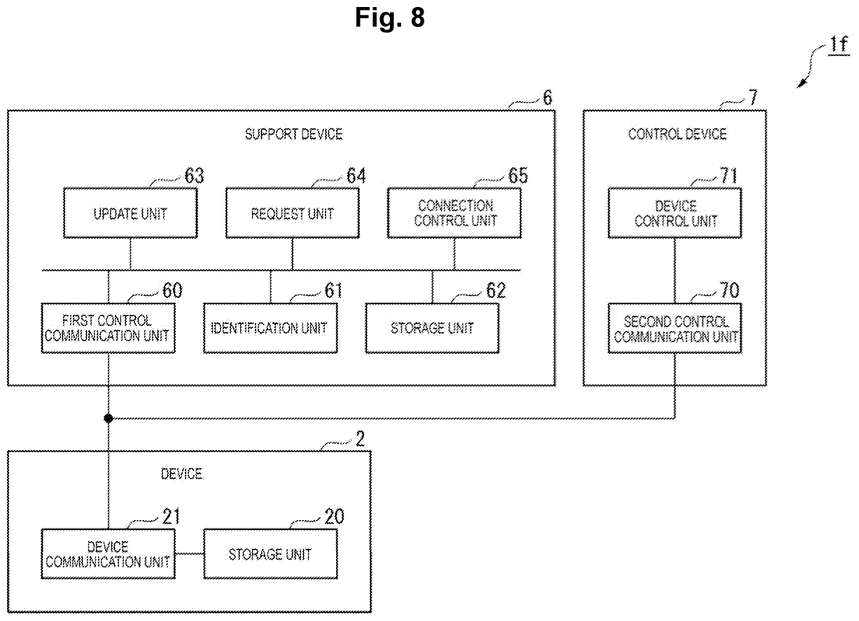

FIG. 8 is a diagram illustrating a configuration example of a communication system 1f. The communication system 1f includes a device 2, a support device 6 (first control device), and a control device 7 (second control device). The support device 6 includes a first control communication unit 60, an identification unit 61, a storage unit 62, an update unit 63, a request unit 64, and a connection control unit 65. The control device 7 includes a second control communication unit 70 and a device control unit 71.

The support device 6 is connected to the control device 7. The support device 6 may be provided in the control device 7. That is, the control device 7 may include a first control communication unit 60, an identification unit 61, a storage unit 62, an update unit 63, a request unit 64, a connection control unit 65, a second control communication unit 70, and a device control unit 71.

The first control communication unit 60, the identification unit 61, the storage unit 62, the update unit 63, the request unit 64, and the connection control unit 65 correspond to the control communication unit 30, the identification unit 31, the storage unit 32, the update unit 33, the request unit 34, and the connection control unit 35 in the control device 3 illustrated in FIG. 1, respectively. The device control unit 71 corresponds to the device control unit 36 in the control device 3 illustrated in FIG. 1.

The first control communication unit 60 executes communication between the support device 6 and the device 2 and communication between the support device 6 and the control device 7. The first control communication unit 60 transmits the network configuration information to the second control communication unit 70. The first control communication unit 60 transmits the setting information of each device 2 to the second control communication unit 70.

The second control communication unit 70 executes communication between the control device 7 and the support device 6 and communication between the control device 7 and the device 2. The second control communication unit 70 outputs the network configuration information acquired from the first control communication unit 60 to the device control unit 71. The second control communication unit 70 outputs the setting information acquired from the first control communication unit 60 to the device control unit 71.

The device control unit 71 uses the second control communication unit 70 to transmit an establishment notification signal to the device 2 that has transmitted the signal acquired by the first control communication unit 60 or the second control communication unit 70. The connection control unit 65 may transmit the establishment notification signal using the first control communication unit 60 instead of the device control unit 71. The device control unit 71 controls the operation of the device 2 by transmitting a control signal to the device 2. The device control unit 71 may acquire the sensor value from the device 2.

Next, an operation example of the communication system 1f will be described.

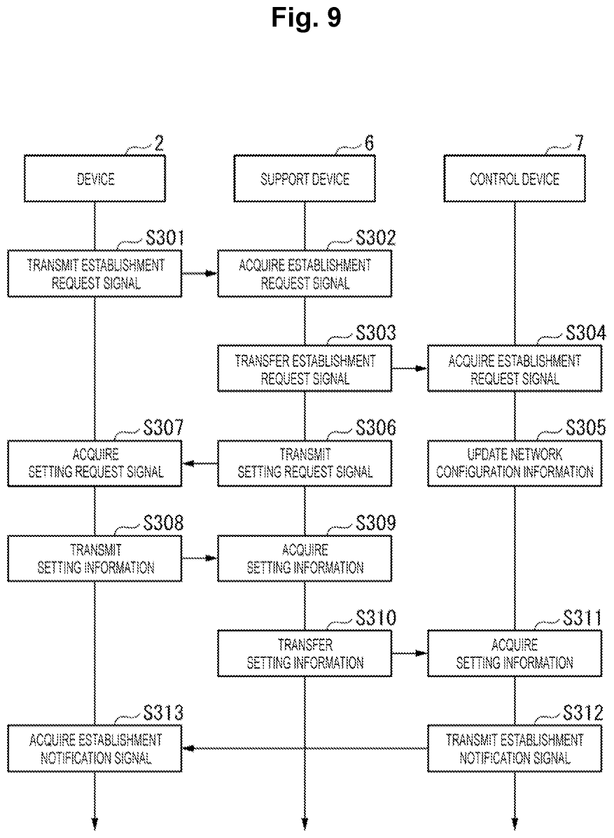

FIG. 9 is a sequence diagram illustrating an operation example of the communication system 1f. The operation illustrated in FIG. 9 is executed when the device 2 is connected to the support device 6 or the control device 7. The device 2 transmits an establishment request signal including identification information of the device 2 to the support device 6 (step S301). The support device 6 acquires the establishment request signal (step S302). The support device 6 transfers the establishment request signal to the control device 7 (step S303). The control device 7 acquires the establishment request signal from the support device 6 (step S304). The control device 7 updates the network configuration information on the basis of the establishment request signal (step S305).

The support device 6 transmits a setting request signal to the device 2 (step S306). The device 2 acquires the setting request signal from the support device 6 (step S307). The device 2 transmits setting information to the support device 6 (step S308). The support device 6 acquires the setting information from the device 2 (step S309). The support device 6 transfers the setting information to the control device 7 (step S310).

The control device 7 acquires the setting information from the support device 6 (step S311). The control device 7 transmits an establishment notification signal to the device 2 (step S312). The device 2 acquires the establishment notification signal from the control device 7 (step S313).

As described above, when the device 2 is directly or indirectly connected to the support device 6 (first control device), the device communication unit 21 transmits identification information of the device 2 to the support device 6. In a case where transmission of setting information regarding communication or control of the device 2 is requested, the device communication unit 21 transmits the setting information of the device 2 to the support device 6. The identification unit 61 acquires the identification information of the device 2 from the device communication unit 21. The update unit 63 updates the network configuration information by adding the identification information of the device 2 to the network configuration information that is information indicating the configuration of the network including the support device 6 or the control device 7 (second control device). The request unit 64 transmits a setting request signal to the device 2 on the basis of the network configuration information. The connection control unit 65 acquires the setting information of the device 2 from the device communication unit 21. When the setting information is acquired, the connection control unit 65 or the device control unit 71 transmits an establishment notification signal to the device 2 on the basis of the network configuration information.

Thus, it is possible to establish communication between the control device and the device without requiring operation of the engineering tool.

Next, a modification example will be described.

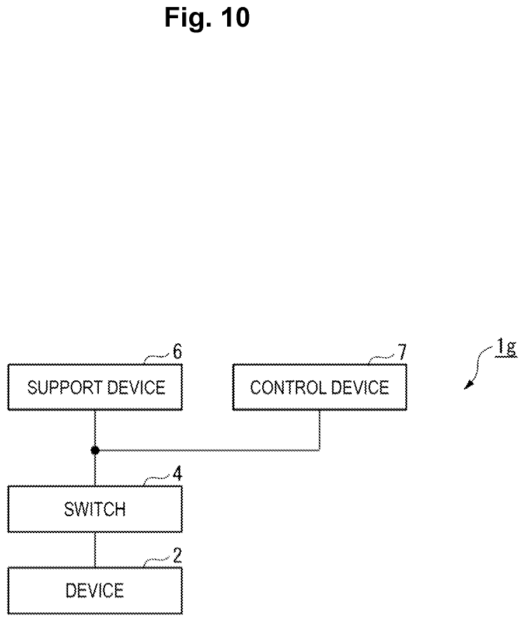

FIG. 10 is a diagram illustrating a first modification example of the configuration of the communication system 1f. A communication system 1g includes a device 2, a control device 7, a switch 4, and a support device 6. The communication system 1g may further include a switch 4.

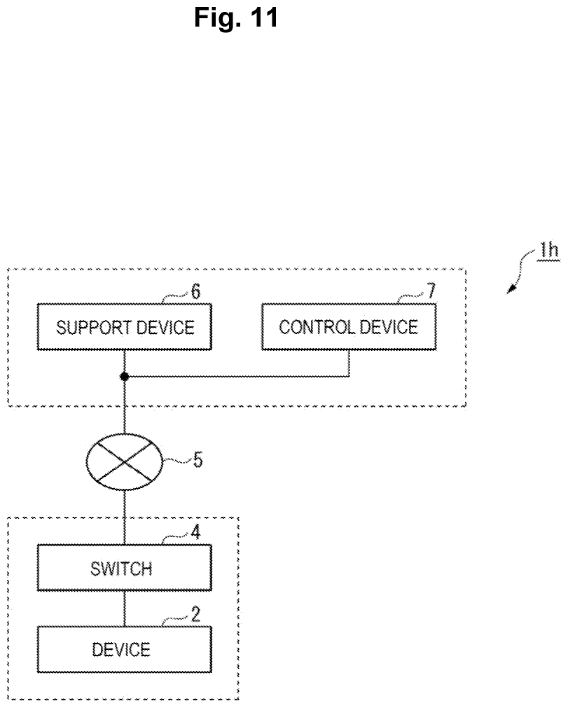

FIG. 11 is a diagram illustrating a second modification example of the configuration of the communication system 1f. A communication system 1h includes a device 2, a control device 7, a switch 4, a communication line 5, and a support device 6. The control device 7 communicates with the device 2 via the communication line 5 and the switch 4. The support device 6 communicates with the device 2 via the communication line 5 and the switch 4. The control device 7 and the support device 6 are provided at a first base. The device 2 and the switch 4 are provided at a second base. The communication system 1h may further include a switch 4.

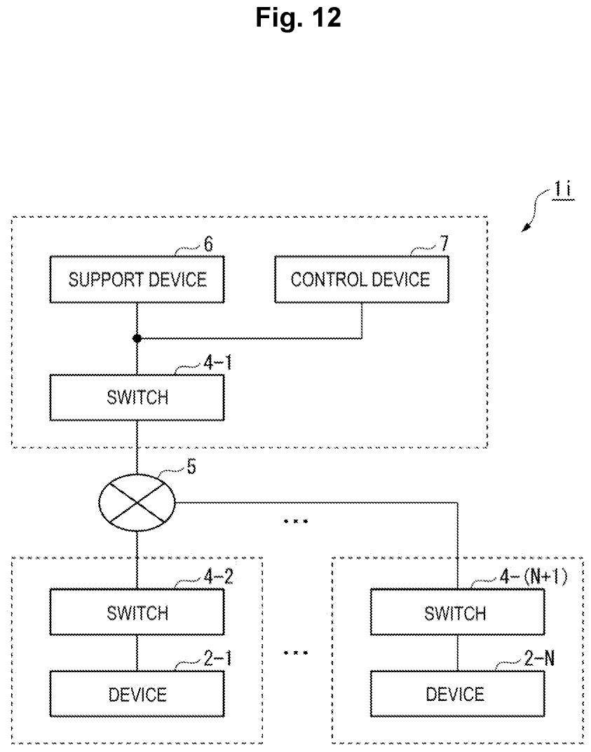

FIG. 12 is a diagram illustrating a third modification example of the configuration of the communication system 1f. A communication system 1i includes N devices 2, a control device 7, “N+1” switches 4, a communication line 5, and a support device 6. The control device 7 communicates with the device 2-n via the switch 4-1, the communication line 5, and the switch 4-(n+1). The support device 6 communicates with the device 2-n via the switch 4-1, the communication line 5, and the switch 4-(n+1).

The control device 7 and the support device 6 are provided at a first base. The device 2-1 and the switch 4-2 are provided at a second base. The device 2-N and the switch 4-(N+1) are provided at an N-th base. The communication system 1i may further include a switch 4.

Each device of each embodiment can also be realized by a computer and a program. In each embodiment, a program may be provided through a network.

Next, a hardware configuration example of the control device in each embodiment will be described.

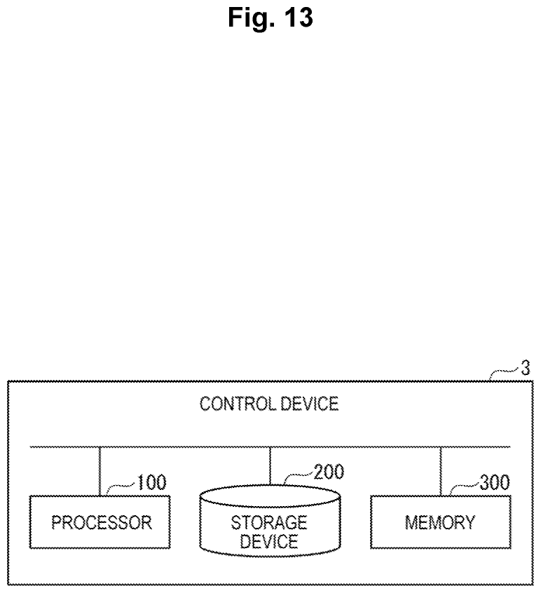

FIG. 13 is a diagram illustrating a hardware configuration example of the control device in each embodiment. Some or all of the functional units of the control device 3 are realized as software by causing a processor 100 such as a central processing unit (CPU) to execute a program stored in a storage device 200 including a non-volatile recording medium (non-transitory recording medium) and a memory 300. The program may be recorded on a computer-readable recording medium. The computer-readable recording medium is, for example, a portable medium such as a flexible disk, a magneto-optical disk, a read-only memory (ROM), or a compact disc read-only memory (CD-ROM), or a non-transitory recording medium such as a storage device such as a hard disk built in a computer system.

Some or all of the functional units of the control device 3 may be realized using hardware including an electronic circuit (electronic circuit or circuitry) in which, for example, a large scale integrated circuit (LSI), an application specific integrated circuit (ASIC), a programmable logic device (PLD), a field programmable gate array (FPGA), or the like is used. The same applies to the control device 7.

Although the embodiments of the present invention have been described in detail with reference to the drawings, the specific configuration is not limited to the embodiments, and includes design and the like without departing from the spirit of the present invention.

### INDUSTRIAL APPLICABILITY

The present invention can be applied to a communication system including a control device that controls a device such as a sensor according to setting information or the like using a software defined network (SDN) technology in an industrial Ethernet (registered trademark) communication system.

### REFERENCE SIGNS LIST

1a, 1b, 1c, 1d, 1e, 1f, 1g, 1h, 1i Communication system
2 Device
3 Control device
4 Switch
5 Communication line
6 Support device
7 Control device
10 Communication system
11 Device
12 Switch
13 Control device
14 Support device
15 GSD file
20 Storage unit
21 Device communication unit
30 Control communication unit
31 Identification unit
32 Storage unit
33 Update unit
34 Request unit
35 Connection control unit
36 Device control unit
60 First control communication unit
61 Identification unit
62 Storage unit
63 Update unit
64 Request unit
65 Connection control unit
70 Second control communication unit
71 Device control unit
100 Processor
200 Storage device
300 Memory

1. A communication system comprising a device and a control device, wherein
the device includes a device communication unit configured to transmit identification information of the device to the control device in a case where the device is connected to the control device, and to transmit setting information regarding communication or control of the device to the control device in a case where transmission of the setting information is requested, and
the control device includes:
an identification unit configured to acquire the identification information of the device from the device communication unit;
an update unit configured to update network configuration information that is information indicating a configuration of a network including the control device by adding the identification information of the device to the network configuration information;
a request unit configured to transmit a signal for requesting transmission of the setting information to the device on the basis of the network configuration information;
a connection control unit configured to acquire the setting information from the device communication unit; and
a device control unit configured to transmit a notification signal indicating that communication has been established to the device.

2. The communication system according to claim 1, wherein
the device control unit generates a control signal on the basis of the setting information and transmits the control signal to the device.

3. A control method executed by a communication system including a device and a control device, the control method comprising:
transmitting, by the device, identification information of the device to the control device in a case where the device is connected to the control device, and transmitting, by the device, setting information regarding communication or control of the device to the control device in a case where transmission of the setting information is requested;
acquiring, by the control device, the identification information of the device from the device;
updating, by the control device, network configuration information that is information indicating a configuration of a network including the control device by adding the identification information of the device to the network configuration information;
transmitting, by the control device, a signal for requesting transmission of the setting information to the device on the basis of the network configuration information;
acquiring, by the control device, the setting information from the device; and
transmitting, by the control device, a notification signal indicating that communication has been established to the device.

4. The control method according to claim 3, further comprising
generating, by the control device, a control signal on the basis of the setting information and transmitting, by the control device, the control signal to the device.

5. A control device comprising:
an identification unit configured to acquire identification information of a device requesting establishment of communication, from the device;
an update unit configured to update network configuration information that is information indicating a configuration of a network including the control device by adding the identification information of the device to the network configuration information;
a request unit configured to transmit a signal for requesting transmission of setting information regarding communication or control of the device to the device on the basis of the network configuration information;
a connection control unit configured to acquire the setting information from the device; and
a device control unit configured to transmit a notification signal indicating that communication has been established to the device.

6. The control device according to claim 5, wherein
the device control unit generates a control signal on the basis of the setting information and transmits the control signal to the device.

7. A non-transitory computer-readable medium having computer-executable instructions that, upon execution of the instructions by a processor of a computer, cause the computer to function as the control device according to claim 5.
